(19) United States
(12) Patent Application Publication
(10) Pub. No.: US 2015/0259257 A1
(43) Pub. Date: Sep. 17, 2015

(54) METALLIZED SAND ROSES AND METHOD OF PRESERVING SAND ROSES

(71) Applicant: Philippe-Guy Woog, Vesenaz (CH)

(72) Inventor: Philippe-Guy Woog, Vesenaz (CH)

(21) Appl. No.: 14/206,861

(22) Filed: Mar. 12, 2014

(51) Int. Cl. C04B 41/51; C25D 3/56; C25D 7/00; C25D 3/54; B05D 5/06; B05D 3/00

(52) U.S. Cl. CPC C04B 41/5166; B05D 5/067; B05D 3/002; C04B 41/5111; C04B 41/5155; C04B 41/5161; C04B 41/5144; C25D 7/00; C25D 3/54; C25D 3/56

(57) ABSTRACT

The present invention is directed toward metallized sand rose compositions and a method of preserving a sand rose by coating the sand rose with a metal or metal alloy. The present invention is more particularly directed to a method of preserving a sand rose by depositing or forming a metal or metal alloy layer on the surface of the sand rose.

### FIELD OF THE INVENTION

The present invention relates generally to the field of sand roses and is directed to a metallized sand rose composition and a method of preserving a sand rose using metallization.

### BACKGROUND OF THE DISCLOSURE

Gypsum is a soft sulfate mineral composed of calcium sulfate dihydrate with the chemical formula CaSO₄—2H₂O. Gypsum is one of the more evaporative minerals in the sedimentary environment and is naturally occurring in several varieties, including alabaster in massive form and selenite in crystalline form.

Selenite mineral is a crystalline form of gypsum. Selenite crystals commonly occur as tubular, reticular and columnar crystals, often with no imperfections or inclusions and can appear water or glass like. At times the crystals include interesting inclusions such as fossils. Satin spar variety is almost prismatic and fibrous in a parallel crystal habit. Another variety of selenite crystals exhibits a rosette formation.

The minerals barite and celestine can also exhibit a rosette formation.

The rosette formation, in particular, can be visually pleasing. However, the rosette formation is brittle, fragile and susceptible to breakage and disintegration. The present invention provides a composition and method that addresses the above and other issues.

### SUMMARY OF THE INVENTION

The present invention is directed toward metallized sand rose compositions and a method of preserving a sand rose by coating the sand rose with a metal or metal alloy. The present invention is more particularly directed to a method of preserving a sand rose by depositing or forming a metal or metal alloy layer on the surface of the sand rose.

### BRIEF DESCRIPTION OF THE DRAWINGS

The present invention will be better understood by reference to the following drawing of which:

FIG. 1 is a metallized sand rose

### DETAILED DESCRIPTION

A sand rose is a mineral formation that results when sand crystallizes with gypsum or barite crystals to form a rosette shape.

Each sand rose forms a uniquely shaped mineral flower. The petals constituting these mineral flowers are actually crystals flattened in the crystallographic axis, fanning open in radiating clusters. Some sand roses consist of a few large blades while other sand roses consist of large clusters of rosettes. Gypsum sand roses thin toward the edge of the blade or petal, where the blade becomes transparent and sharp. The edges of the gypsum or selenite sand roses are sharper and the crystalline structure thereof is less hard and more delicate than the sand roses formed from barite. The blades or petals taper as the blades and petals extend from the center of the sand rose. In some circumstances sand roses look remarkably like a spherical rose flower with its petals wide open.

Sand roses are found in a variety of sizes, ranging from a small rosette that is a centimeter in diameter to large clusters that exceed more than one meter in diameter. A sand rose crystal can be free-floating or attached to a matrix or base rock.

Gypsum sand roses are found in arid regions all over the world, such as California, Libya, Mexico, Egypt and Saudi Arabia, in lake muds, clay beds, evaporated seas, salt flats, salt springs, caves and deserts. Sand roses frequently occur in arid sandy environments such as the evaporation of shallow salt basins. Sand roses form when water evaporates in arid sandy conditions, usually after a short rain. During the growth of the sand rose grains of sand remain trapped in the gypsum. Gypsum and in particular the selenite variety of gypsum is transparent. The trapped sand grains give the sand rose the color of the surrounding desert soil that may be different depending upon where the desert rose is created. Gypsum sand roses are generally brown, reddish, or dusty rose in color.

Sand roses can take years, even hundreds of years, to form depending upon the levels of gypsum in the groundwater. Weather conditions also contribute to the formation of sand roses. Gypsum sand roses are extremely water soluble and if the pH levels and compositions of the groundwater alter too much the sand rose will simply dissolve.

When a sand rose outcrops, if the sand rose is left to the weather, the embedded sand grains become lighter as the sand grains oxidize and the gypsum matrix turns white and soft. Eventually the sand rose will transform from a solid mineral formation to a powder. The length of time it takes the sand rose to erode and dissolve into a powder depends upon the size of the sand rose.

Some sand roses can appear and be found at the ground surface. However, surface appearing gypsum sand roses are often damaged because gypsum is a soft mineral. If left on the ground surface exposed to weather, the sand roses transform or degrade quickly.

Sand roses typically crystallize about one meter below the ground surface. Digging to the water table locates well-formed and undamaged sand roses, that can be difficult to extract because of the suction of wet sand on the contorted surface of the sand rose. Newly dug sand roses are quite fragile and easy to break. The sand roses harden as they dry but remain a soft mineral classified at about a “2” on the Mohs scale of Hardness and can be scratched with a fingernail. As a result care must be taken during the extraction process as well as subsequent handling and packing thereof.

Gypsum is not stable in the presence of water and humidity. If left exposed to weather, sand roses will degrade. If protected from weather the sand roses can still degrade depending upon the amount of humidity in the air.

Coating a gypsum sand rose with a metal or metal alloy encapsulates the fragile sand rose structure and creates a brilliant, metallized sand rose composition that retains the unique structure of the original sand rose. The metal layer prevents the degradation of the sand rose through erosion and humidity. In addition, the metallized sand rose composition is strengthened and the blades or petals become resistant to breakage. Furthermore, coating the entire sand rose surface encloses any impurities that can exist in the sand rose, including but not limited to bacteria present in the soil, within the metallized sand rose composition thereby preventing proliferation of any impurities such as bacteria and reducing exposure thereto.

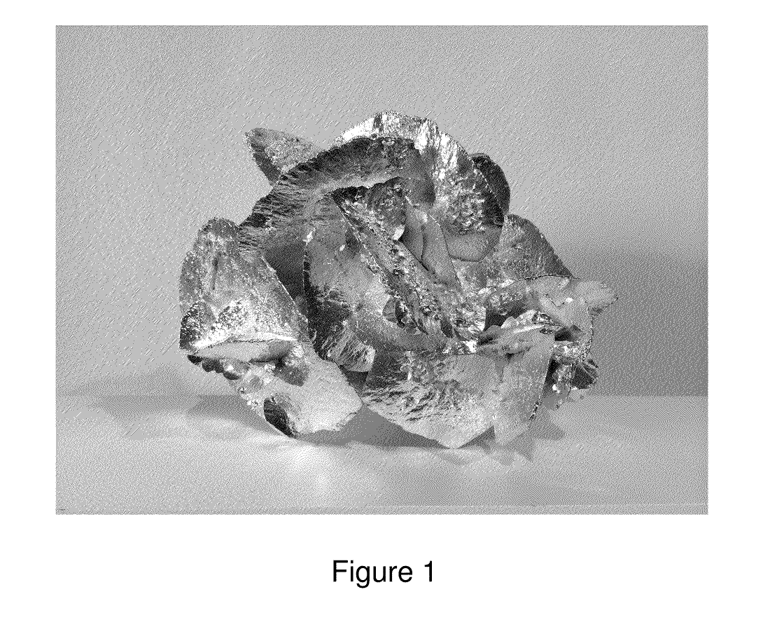

Referring now to FIG. 1, illustrated is a metallized gypsum sand rose composition of the present invention. In this embodiment, the sand rose illustrated is coated using electroplating technology with a brilliant layer of sterling silver to form a composition consisting of a sand rose and sterling silver. The delicate edges of the blades or petals are sharply defined and visibly distinct. The sand rose composition consisting of a sand rose and sterling silver creates an attractive sculpture with visual appeal.

The dimensions of the sand rose illustrated in FIG. 1 are 16.5 cm height, 30 cm width and 25 cm diameter. The metallized sand rose shown weighs 4,800 g. This description being for illustrative purposes only without intent to limit the invention. The dimensions and weight of a metallized sand rose composition in accordance with the present invention are not limited to the illustrated metallized sand rose composition in FIG. 1. The dimensions and weight of the metallized sand rose composition in accordance with the present invention can be higher or lower and are dependent upon the actual size of the sand rose selected to be metallized and the metal or metal alloy material used to coat the sand rose. The metal material may include any metal which is suitable for metallization. Exemplary metals include aluminum, copper, tin, zinc, platinum, titanium, lead, nickel, iron, gold, silver, chrome and the like. Exemplary metal alloys include copper based alloys, aluminum based alloys, titanium based alloys, iron based alloys and corrosion and/or abrasion resistant alloys.

The present invention is also directed to a method of preserving a sand rose by metallizing the sand rose. Metallizing is the process of coating metal or metal alloy onto a non-metallic surface.

The application of a metal or metal alloy coating is well known in the art. Exemplary metallizing processes include galvanization, electroplating, electrodeposition metallization, metal spraying, hot dip metallization, diffusion metallization, vacuum metallization, sputtering, ion implantation or ion plating and contact metallization. Exemplary metallizing techniques include aluminizing, chromium plating, zinc coating, tin plating, cadmium plating, copperizing, nickel plating, lead plating, silver plating, gold plating and the like. Suffice to say, the metallizing process for the present invention covers the surface of the sand rose with a layer of metal or metal alloy. The metallization process is selected in view of the size of the sand rose to be coated and the coating material. Electroplated coatings tend to be thin and brightly reflective. In the present invention galvanization/electroplating processes are particularly suitable for copper, silver, nickel, sterling silver, yellow gold and pink gold materials. Vacuum metallization is particularly suitable to evenly coat larger sand rose specimens and to add color to the metallic coating.

In one embodiment utilizing a vacuum metallization process, the metal or metal alloy layer is deposited on the sand rose by evaporating the metal or metal alloy and recondensing it on the sand rose surface. The process is carried out in a chamber from which the air is evacuated until the residual pressure is approximately one-millionth normal atmospheric pressure. The sand rose is cleaned and then the cleaned sand rose is mounted within a vacuum chamber in such a way that it is exposed by line of sight to the metal vapor. The metal vapor is produced by heating the metal to be evaporated to such a temperature that its vapor pressure appreciably exceeds the residual pressure within the chamber. Thus, the metal is converted to a vapor and is transferred in this form to the surface of the relatively cool sand rose.

In another embodiment utilizing electroplating, the sand rose and the metal or metal alloy material are immersed in an electrolyte solution containing one or more dissolved metal salts as well as other ions that permit the flow of electricity. A power supply supplies a direct current to the anode made of the metal to be plated, oxidizing the metal atoms that comprise it and allowing them to dissolve in the solution. At the cathode comprising the sand rose, the dissolved metal ions in the electrolyte solution are reduced at the interface between the solution and the sand rose, such that they “plate out” onto the sand rose. The rate at which the metal or metal alloy, is dissolved is equal to the rate at which the sand rose, is plated, vis-a-vis the current flowing through the circuit

It may be desirable to produce a metal or metal alloy layer that includes a non-metallic color. Exemplary colors include green, lilac, magenta, blue, orange, red, and the like. To achieve this result, pigment can be incorporated in the metallizing step. For instance, during the electroplating process described herein pigment can be added to the highly concentrated liquid solution of metal salts and will be plated along with the metal or metal alloy. Alternatively, the color can be added in a separate step subsequent to the metallizing step wherein the metal or metal alloy layer is coated with a color coating. The color coating is preferably transparent to maintain the benefit of the reflective properties of the metal or metal alloy layer. Exemplary color coating materials include metal oxides or other pigment containing material or resin.

The structure of the layer of metal or metal alloy and its features depends upon the conditions of the coating process, cleanness of surface of the sand rose and features of the metal or metal alloy and sand rose.

To achieve a brilliant blemish-free coating, the sand rose must be free of surface contaminates such as mold releases, fingerprints, dust, dirt, oil and grease. Accordingly, the present invention contemplates the additional step of cleaning the sand rose and preparing the sand rose for coating with metal. In one embodiment the cleaning step consists of dusting the sand rose with a fine brush. The cleaning step can serve a dual purpose. When the sand rose is cleaned with an acid or an alcalic solution, the surface of the sand rose is also prepared for the metal to adhere to the surface. Other cleaning methods and surface preparation methods and techniques can be employed in the present invention.

The present invention contemplates the creation of a sculpture of extraordinary and breath-taking appeal by encapsulating a mineral sand rose in a metal or metal alloy. The metal or metal alloy is coated onto the surface of the sand rose. As a result the structure of the unique mineral flower is reinforced and maintained. More particularly, the fragile sand rose petals are reinforced and strengthened creating an aesthetically pleasing three-dimensional metal coated sculpture or structure in the form of a sand rose. The reflective properties of the metal or metal alloy define more sharply and distinctly the natural positioning and extension of the blades or petals thereby capturing, preserving and enhancing the beauty of this mineral flower. The result is an extraordinary preservation of a unique mineral flower structure that otherwise would simply erode or dissolve.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A metallized sand rose comprising a sand rose and a coating formed on the sand rose, said coating comprising a metal or metal alloy material.

2. The metallized sand rose of claim 1 wherein said metal or metal alloy material comprises gold, rose gold, vaporized metal, copper, sterling silver, nickel, platinum, aluminum, zinc, tin, titanium, chrome, lead, iron, copper based alloys, aluminum based alloys, titanium based alloys and iron based alloys.

3. The metallized sand rose of claim 1 wherein said coating further includes pigment.

4. The metallized sand rose of claim 1 wherein said sand rose is preserved.

5. The metallized sand rose of claim 1 wherein said coating encapsulates said sand rose and acts as a protective barrier.

6. The metallized sand rose of claim 5 wherein said coating acts as a protective barrier against proliferation of bacterias.

7. A method of preserving a sand rose comprising the step of coating the surface of the sand rose with a metal or metal alloy.

8. The method of claim 7 wherein said step of coating comprises metallizing.

9. The method of claim 7 wherein said step of coating comprises electroplating, electrotyping, galvanizing or vacuum metallizing.

10. The method of claim 7 wherein said method of preserving a sand rose prevents erosion and strengthens the sand rose structure.

11. The method of claim 7 wherein said method encapsulates the entire sand rose.

12. The method of claim 7 wherein said metal comprises gold, rose gold, vaporized metal, copper, sterling silver, nickel, platinum, aluminum, zinc, tin, titanium and chrome.

13. The method of claim 7 wherein said metal alloy comprises copper based alloys, aluminum based alloys, titanium based alloys and iron based alloys.

14. The method of preserving a sand rose of claim 7, further comprising the steps of selecting a sand rose and cleaning the sand rose, prior to coating the surface of the sand rose with a metal or metal alloy.

15. The method of claim 14 wherein said coating comprises metallizing.

16. The method of claim 15 wherein said metallizing comprises electroplating, electrotyping, galvanizing or vacuum metallizing.

17. The method of claim 14 wherein said metal comprises gold, rose gold, vaporized metal, copper, sterling silver, nickel, platinum, aluminum, zinc, tin, titanium and chrome.

18. A method of creating a sculpture comprising the steps of selecting a sand rose and preserving the sand rose by metallizing the sand rose.
